(19) United States
(12) Patent Application Publication
(10) Pub. No.: US 2006/0040605 A1
(43) Pub. Date: Feb. 23, 2006

(54) Instrument panel integrated defroster duct

(75) Inventor: Hyun-Dong Lee, Yongin-si (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Seoul (KR)

(21) Appl. No.: 11/167,151

(22) Filed: Jun. 28, 2005

(30) Foreign Application Priority Data
Aug. 17, 2004 (KR) 2004-64736

(51) Int. Cl. B60S 1/54

(52) U.S. Cl. 454/121; 454/127

(57) ABSTRACT

An instrument panel integrated defroster duct includes a defroster duct having a plurality of integrally formed ducts that guide an air stream into a vehicle compartment, an instrument panel covering the upper side of the defroster duct, a welding part having a protrusion formed at the defroster duct by a predetermined length, the welding part integrally forming a joining section between the instrument panel and the defroster duct by vibration welding, and a connecting part integrally connecting an uneven section of the defroster duct to the instrument panel using a screw.

### RELATED APPLICATIONS

The present disclosure relates to subject matter contained in Korean Application No. 10-2004-64736, filed on Aug. 17, 2004, which is herein expressly incorporated by reference its entirety.

### BACKGROUND OF THE INVENTION

1. Field of the Invention

The present invention relates to an instrument panel integrated defroster duct and more particularly, to an instrument panel integrated defroster duct in which joining parts between a defroster duct having integrally formed defroster ducts and an instrument panel are selectively joined by a welding part for vibration-welding using heat and a connecting part for connecting using a screw, so as to reduce work to couple the instrument panel to the defroster duct and to maximize the joining force between the instrument panel and the defroster duct.

2. Description of the Related Art

Generally, an instrument panel is installed with defrost grills at the upper and side surfaces of the instrument panel for preventing windshield glass and door glass from frosting up. The defrost grill is communicated with a defroster duct extended from a defroster which is provided at the rear side of the instrument panel.

The defroster duct includes a main defroster duct for removing frost, a side defroster duct for removing frost, a center air vent duct for supplying air, and a side air vent duct for supplying air, while the entire component is injection-molded.

Japanese Utility Model Laid-Open No. 62-056,306 has proposed an attaching structure of a resin duct including a ring-sed duct wall expand along the side of an attaching bracket, and a spherical duct wall corresponding to an opening of the attaching bracket, while the attaching bracket and the duct are fixed by a ring-shaped expand portion and a spherical expanded portion.

Moreover, Korean Utility Model Laid-Open No. 2001-2045 has proposed a duct install structure of a defroster in which a defroster duct including a plurality of ducts for guiding an air steam into the vehicle's compartment is integrally formed with an instrument panel, and the defroster duct is welded to an instrument panel core by a ten vibration welding machine using vibration.

As describe above, the conventional instrument panel and the conventional defroster duct are connected or welded to each other so as to be integrally coupled to each other.

However, in conventional instrument panels and defroster ducts, the use of screws complicates the assembly process and greatly increases the time and work required for assembly. Gaps occur between the parts connected by the screws, and thus noise is generated and fluid is introduced into the vehicle when traveling.

In addition, if the conventional instrument panel is assembled to the conventional defroster duct by only welding, the gaps between the welding surfaces are not uniform so that the conventional instrument panel cannot be welded to the conventional defroster duct.

### SUMMARY OF THE INVENTION

Therefore, the present invention has been made in view of the above and/or other problems, and it is an object of the present invention to provide an ins ent panel integrated ester duct in which a defroster duct having integrally formed defroster ducts and an instrument panel are joined to each other by a welding part for vibration-welding the same using heat and a connecting part for connecting the same using a screw depending on whether a gap between the instrument panel and the defroster duct is large or small, so as to decrease the work needed by reducing the number of screws and to conveniently assemble the same due to the vibration-welding.

In accordance with the present invention, the above and other aspects can be accomplished by the provision of an instrument panel integrated defroster duct including a defroster duct having a plurality of integrally formed ducts for guiding an air stream into a vehicle compartment, an instrument panel covering the upper side of the defroster duct, a welding part, paving a protrusion formed at the defroster duct by a predetermined length, for integrally forming a joining section between the instrument panel and the defroster duct by vibration welding and a connecting part for integrally connecting uneven sections of the defroster duct to the instrument panel using a screw.

### BRIEF DESCRIPTION OF THE DRAWINGS

These and/or other aspects and advantages of the present invention will become apparent and more readily appreciated from the following description of the embodiments, taken in conjunction with the accompanying drawings, in which.

FIG. 1 is an exploded perspective view illustrating an instrument panel integrally formed with a defroster duct according to the present invention;

FIG. 2 is an exploded perspective view of the instrument panel and the defroster duct according to the present invention;

FIG. 3 is a sectional view taken along the line A-A in FIG. 1;

FIG. 4 is a sectional view taken along the line B-B in FIG. 1; and

FIG. 5 is a sectional view taken along the line C-C in FIG. 1.

### DESCRIPTION OF THE PREFERRED EMBODIMENT

Hereinafter, the preferred embodiment according to the present invention will be described in detail with reference to the accompanying drawings.

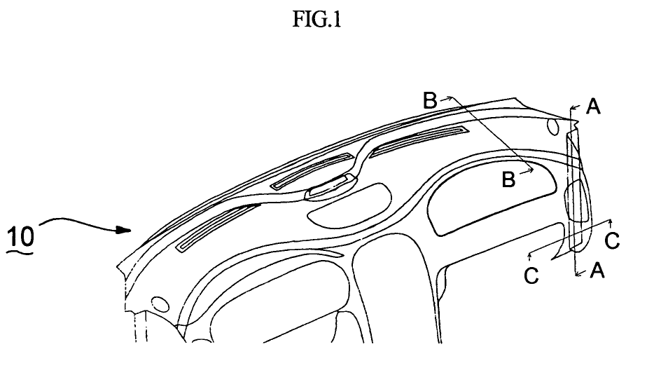

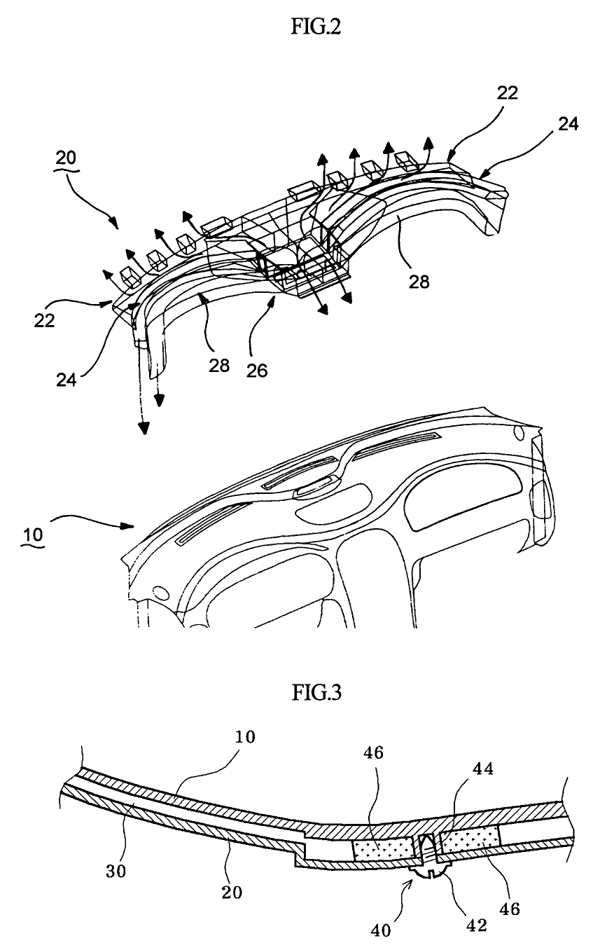

FIG. 1 is an exploded perspective view illustrating an instrument panel integrally formed with a defroster duct according to the present invention, and FIG. 2 is an exploded perspective view of the instrument panel and the defroster duct according to the present invention.

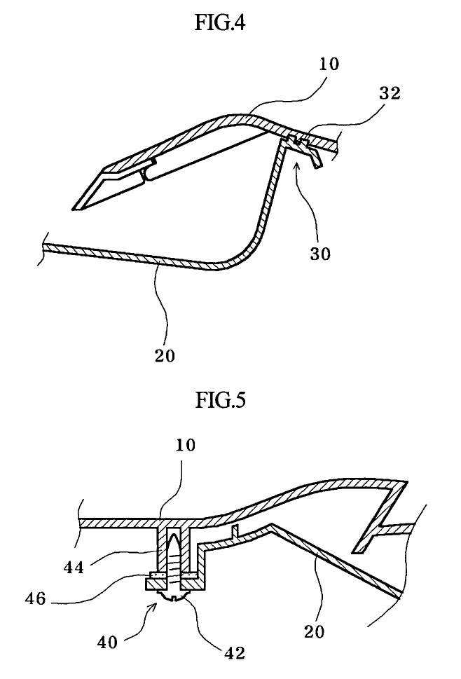

Moreover, FIG. 3 is a sectional view taken along the line A-A in FIG. 1, FIG. 4 is a sectional view taken along the line EBB in FIG. 1, and FIG. 5 is a sectional view taken along the line C-C in FIG. 1.

As shown in FIGS. 1 to 5, a defrost duct integrally formed with an instrument panel according to the preferred embodiment of the present invention includes an instrument panel 10 and a defroster duct 20 integrally formed with the instrument panel 10.

The defroster duct 20 includes a duct body 22 for removing frost, a side duct 24 for removing frost a center duct 26 for supplying air, and a side duct 28 for supplying air, while the components of the defroster duct 20 are integrally inject-molded during manufacturing.

The instrument panel 10 and the defroster duct 20 are integrally joined to each other.

The instrument panel 10 and the defroster duct 20 are temporarily joined, and then inter by a welding part 30 which are selectively vibration-welded along the temporarily joined portions by heat and a connecting part 40 connected by a screw 42.

The welding part 30 and the connecting part 40 are selectively formed according to whether the gap between the instrument panel 10 and the defroster duct 20 is large or small.

In other words, when the instrument panel 10 and the defroster duct 20 are temporarily joined, the temporary-assembly of the instrument panel 10 and the defroster duct 20 has the welding part 30 formed at a section having uniform surfaces and vibration welded by heat and the connecting part 40 formed at a section having uneven surfaces and connected by the screw 42.

The welding part 30 is welded by a well-known vibration welding machine, and the vibration welding using heat may be not performed well when any one of the welding part to be welded is slanted over 10 degrees.

Since the instrument panel 10 has an uneven lower surface facing the defroster duct 20, it is difficult to maintain a uniform gap between the instrument panel 10 and the defroster duct 20.

Thus, as shown in FIGS. 3 and 4, the instrument panel 10 and the defroster duct 20 are preferably integrated to each other by welding and connecting the welding part 30 and the connecting part 40 simultaneously.

The defter duct 20 has protrusions 32 formed at the portion where the welding part 30 is formed, and the protrusions 32 come in contact with and are vibration-welded to the lower side of the instrument panel 10.

The welding part 30 is formed at the portion where the defrost duct 20 is near to the instrument panel 10.

As shown in FIGS. 3 and 5, the connecting part 40 is formed at the portion where the instrument panel 10 contacting the defroster duct 20 is not parallel and uneven.

The connecting part 40 indicates that the defroster duct 20 is connected to the instrument panel 10 by inserting the screw 42 through the lower side of the defroster duct 20.

In order to prevent the screw 42 from being exposed to the upper side of the instrument panel 10, the instrument panel 10 is formed with a connecting protrusion 44 protruded from the lower side of the instrument panel 10 by a predetermined length.

The connecting protrusion 44 is formed with a boss therein and a female thread formed on the inner surface of the boss to be engaged with the screw 42.

A pad 46 is disposed between the instrument panel 10 and the defroster duct 20 so as to seal the gap between the instrument panel 10 and the defroster duct 20.

The pad 46 is made of a sponge or rubber and prevents external air or moisture from introducing into the connected portion.

As described above, according to the defroster duct integrated with an instrument panel, since a plurality of ducts are integrally inject-molded so as to reduce the number of processes for molding, and the instrument panel and the defroster duct are coupled to each other by the vibration-welding and the screw, work to connect the instrument panel to the defroster duct are reduced and the joining force between the int ent panel and the defroster duct is increased.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An instrument panel integrated defroster duct comprising:
a defroster duct having a plurality of integrally formed ducts that guide an air stream into a vehicle compartment;
an instrument panel covering the upper side of the defroster duct;
a welding part having a protrusion formed at the defroster duct by a predetermined length, the welding part integrally forming a joining section between the instrument panel and the defroster duct by vibration welding; and
a connecting part integrally connecting an uneven section of the defroster duct to the instrument panel using a screw.

2. The instrument panel integrated defroster duct as set forth in claim 1, wherein the connecting part is sealed by disposing a pad between the defroster duct and the instrument panel.

3. The instrument panel integrated defroster duct as set forth in claim 1, wherein the instrument panel comprises a connecting protrusion formed at the portion corresponding to the connecting part and engaged with the screw.
